(19) United States
(12) Patent Application Publication
(10) Pub. No.: US 2026/0014471 A1
(43) Pub. Date: Jan. 15, 2026

(54) COMPUTER SYSTEM AND GAME CONTROL METHOD

(71) Applicant: BANDAI NAMCO ENTERTAINMENT INC., Tokyo (JP)

(72) Inventors: Hideaki SAKAI, Tokyo (JP); Kohei IKEDA, Kawasaki-shi (JP)

(73) Assignee: BANDAI NAMCO ENTERTAINMENT INC., Tokyo (JP)

(21) Appl. No.: 19/335,855

(22) Filed: Sep. 22, 2025

Related U.S. Application Data
(63) Continuation of application No. PCT/JP2024/012032, filed on Mar. 26, 2024.

(30) Foreign Application Priority Data
Mar. 30, 2023 (JP) 2023-055899

(51) Int. Cl. A63F 13/56; A63F 13/798

(52) U.S. Cl. CPC A63F 13/56; A63F 13/798

(57) ABSTRACT

A game system is a computer system that controls execution of a game in which a player enjoys operating a player character. The game system generates operation individuality information for each player, based on operation information of the player character by the player. The game system automatically controls a given control target character, based on the operation individuality information of a plurality of selection players.

### CROSS REFERENCE TO RELATED APPLICATIONS

This application is a continuation of International Patent Application No. PCT/JP2024/012032, having an international filing date of Mar. 26, 2024, which designated the United States, the entirety of which is incorporated herein by reference. Japanese Patent Application No. 2023-055899 filed on Mar. 30, 2023 is also incorporated herein by reference in its entirety.

### BACKGROUND OF THE INVENTION

Some video games feature non player characters (NPCs) that are automatically controlled by a computer, in addition to player characters operated by players. There are various methods for automatically controlling NPCs, but they can be broadly divided into methods that use “game artificial intelligence (AI)”, more specifically, “character AI”, and “ghost character” methods that control NPCs based on data input by the player.

In the methods using character AI, a computer executes a calculation process called character AI, autonomously judges the situation at each moment during the game referring to various types of information, and determines the actions of the NPCs. The more character AI can make the NPCs act as if they were being controlled by a human, the better it is considered to be.

The ghost character methods can be divided into two types: (1) a type in which time series information of the player's operation input is saved as it is, and at automatic control of the NPC, the time series information is traced to reproduce the past actions of the player character as it is, and (2) a type in which the operation inputs are statistically processed and saved as operation individuality information, and the operation individuality information is reflected in the automatic control of the NPC. The former type is a type in which the player character who recorded the fastest time appears as a ghost in a racing game, for example, and control is performed to reproduce the player's operations in time series.

In the latter “type that reflects operation individuality information”, automatic control is performed to reflect the operation individuality of the original player, that is, the “habits” of operation. Therefore, NPCs controlled by the type that reflects operation individuality information behave autonomously as if a person is actually present and operating them, rather than in the case of performing automatic control by simply reproducing the time series information of the operation inputs (see Japanese Unexamined Patent Application Publication No. 2011-156405 and Japanese Unexamined Patent Application Publication No. 2012-24618, for example).

In conventional automatic control of the “type that reflects operation individuality information”, each time automatic control of an NPC is started, the operation individuality information of one player selected from many players who have played in the past is referenced, so the behavioral diversity of the NPC is limited to the number of players who have played in the past.

### BRIEF DESCRIPTION OF THE DRAWINGS

FIG. 1 is a system configuration diagram illustrating a configuration example of a game system.

FIG. 2 is a diagram for describing various types of data stored in association with play in a player-versus-player (PvP) mode.

FIG. 3 is a diagram illustrating a data configuration example of situation definition data.

FIG. 4 is a diagram illustrating a data configuration example of user management data.

FIG. 5 is a diagram for describing automatic control in a case where a template character is selected as a control target character in a practice mode.

FIG. 6 is a diagram for describing automatic control in a case where a ghost character is selected as the control target character in the practice mode.

FIG. 7 is a diagram for describing a display example of a setting screen in the practice mode, selection of the control target character to be used as a ghost character, and selection of the selection player 7.

FIG. 8 is a diagram for describing generation of ghost control information.

FIG. 9 is a diagram illustrating a data configuration example of mixing ratio definition data.

FIG. 10 is a block diagram illustrating a functional configuration example of a server system.

FIG. 11 is a diagram illustrating an example of programs and data stored in a server storage section.

FIG. 12 is a functional block diagram illustrating a functional configuration example of a user terminal.

FIG. 13 is a flowchart for describing the flow of a PvP mode process.

FIG. 14 is a flowchart for describing the flow of a practice mode process.

FIG. 15 is a flowchart continued from FIG. 14.

FIG. 16 is a flowchart for describing the flow of a practice mode process in a second embodiment.

FIG. 17 is a flowchart continued from FIG. 16.

FIG. 18 is a diagram for describing a modification example.

### DETAILED DESCRIPTION

The following disclosure provides many different embodiments, or examples, for implementing different features of the provided subject matter. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. Further, when a first element is described as being “connected” or “coupled” to a second element, such description includes embodiments in which the first and second elements are directly connected or coupled to each other, and also includes embodiments in which the first and second elements are indirectly connected or coupled to each other with one or more other intervening elements in between.

In accordance with one of some embodiments, there is provided a computer system comprising at least one processor or circuit programmed to execute:
generating operation individuality information, which is a gathering of information for each of predetermined detailed items, for each player playing a game, based on operation information of a player character by the player;
generating control information for use in automatic control of a given control target character, based on the operation individuality information of a plurality of selection players; and
automatically controlling the control target character using the control information.

According to the disclosure, in some embodiments, the computer system can automatically control the control target character based on the operation individuality information of the plurality of selection players. Therefore, the diversity of the automatic control of the NPC is not limited to the number of players who have played in the past, unlike in the conventional cases.

A second disclosure is a computer system in which, in the above computer system, generating the control information includes generating the control information by selecting, for each of the detailed items, the operation individuality information of the selection player to be adopted.

According to the disclosure, in some embodiments, by creating the control information for each detailed item, the computer system can automatically control the control target character such that the operation individuality of the selection player is expressed for each detailed item. The diversity of the control target character's actions can be increased simply by adapting different detailed items from different selection players.

A third disclosure is a computer system in which, in the above computer system, generating the control information includes selecting the operation individuality information of the selection player to be adopted for each of the detailed items such that the operation individuality information is at a given ratio among the players.

According to the disclosure, in some embodiments, the computer system can further diversify the actions of the control target character by changing the ratio of the detailed items adopted among the plurality of selection players.

A fourth disclosure is a computer system in which, in the above computer system, generating the control information includes selecting a selection player to be adopted from the plurality of selection players based on the operation individuality information of the selection player.

According to the disclosure, in some embodiments, the computer system can select a selection player based on the operation individuality information of the selection player. For example, if the operation individuality information of a selection player includes a detailed item that particularly shows the operation individuality of the selection player, the selection player can be selected for the detailed item.

A fifth disclosure is a computer system in which, in the above computer system, generating the control information includes selecting a selection player to be adopted from the plurality of selection players based on play performance information of the selection player.

According to the disclosure, in some embodiments, the computer system can select a selection player based on the play performance information of the selection player, making it possible to select a relatively “skilled” or “strong” player as the selection player, for example.

A sixth disclosure is a computer system in which, in the above computer system, generating the control information includes generating the control information by compositing the operation individuality information of the plurality of selection players at a given ratio for each of the detailed items.

According to the disclosure, in some embodiments, the computer system can automatically control the control target character with control information in which the operation individualities of the plurality of selection players are composited. Changing the ratio increases the variety of automatic control of the control target character.

A seventh disclosure is a computer system in which, in the above computer system, generating the control information includes generating the control information by averaging the operation individuality information of the plurality of selection players for each of the detailed items.

According to the disclosure, in some embodiments, the computer system can automatically control the control target character with control information in which the operation individualities of the plurality of selection players are averaged.

An eighth disclosure is a computer system in which, in the above computer system, generating the control information includes determining the ratio of each of the detailed items based on the operation individuality information of the plurality of selection players.

According to the disclosure, in some embodiments, the computer system can determine the ratio of the detailed items depending on the operation individualities of the plurality of selection players. Not only does this increase the variety of control of the control target character, but depending on how the ratio is determined, it is possible to control the control target character in a way that is beneficial to the player. For example, in a case where an NPC in a fighting game is set as the control target character, the ratio of selected detailed items related to a specific attack technique is set high based on the operation individuality information of a selection player who is skilled in using the specific attack technique. Then, the control target character becomes an NPC that is suitable as a practice partner for practicing how to deal with the specific attack technique.

A ninth disclosure is a computer system as defined in which, in the above computer system, the game is a game in which the player operates a character selected from a plurality of types of characters prepared in advance, as a player character,
generating the operation individuality information includes generating the operation individuality information for each of the plurality of types of characters, based on the operation information in a case where the character is set as a player character, and
performing the automatic control includes automatically controlling the control target character, based on the operation individuality information in a case where a character corresponding to the type of the control target character is set as a player character, among the operation individuality information of the selection player.

According to the disclosure, in some embodiments, in a game in which the player selects a player character from among a plurality of types of characters, the computer system can diversify the automatic control of the control target character.

A tenth disclosure is a computer system in which, in the above computer system, performing the automatic control includes:
performing the automatic control in response to a request operation of a player who desires the automatic control; and
performing a cost collection control for collecting a given cost from the player who desires the automatic control.

According to the disclosure, in some embodiments, the computer system can collect a cost from a player who wishes to have the control target character that reflects the player's operation individuality appear in the game.

An eleventh disclosure is a computer system in which, in the above computer system, performing the automatic control includes changing a degree of automatic control of the control target character according to the operation individuality information, based on the amount of the cost.

According to the disclosure, in some embodiments, the computer system changes the degree of the automatic control depending on the amount of the cost, thereby providing even greater versatility.

A twelfth disclosure is a computer system in which, in the above computer system, further programmed to execute selecting the selection player based on an operation input of a player who desires the automatic control.

According to the disclosure, in some embodiments, the player himself/herself can select the selection player.

A thirteenth disclosure is a computer system in which, in the above computer system, further programmed to execute selecting the selection player based on play performance information of a player who desires the automatic control.

According to the disclosure, in some embodiments, the computer system can select the selection player according to the play performance of the player wishing the automatic control. For example, in a fighting game, if a selection player with slightly higher skill than the player wishing the automatic control is selected, the control target character becomes suitable as an NPC for a practice partner of the player wishing the automatic control to improve his/her skill.

A fourteenth disclosure is a computer system in which, in the above computer system, the operation individuality information includes information indicating what action the player character is made to take in a given game situation.

According to the disclosure, in some embodiments, the computer system can reflect the tendency of the selection player to choose what action to take depending on the game situation in the automatic control of the control target character.

A fifteenth disclosure is a computer system in which, in the above computer system, the operation individuality information includes information on a series of actions taken by the player character.

The “information on a series of actions” refers to information on a combination of a series of actions that are considered to be temporally continuous in the time-series memory of actions. For example, in fighting games, this would include “traps,” “combos,” and “continuous moves” that consist of a plurality of moves being performed in succession.

According to the disclosure, in some embodiments, the computer system can automatically control the control target character in which operation individuality including information on a series of actions is reflected.

In accordance with one of some embodiments, there is provided a game control method executed by a computer system, the game control method comprising:
generating operation individuality information, which is a gathering of information for each of predetermined detailed items, for each player playing a game, based on operation information of a player character by the player;
generating control information for use in automatic control of a given control target character, based on the operation individuality information of a plurality of selection players; and
automatically controlling the control target character using the control information.

According to the disclosure, in some embodiments, it is possible to implement the game control method that allows the computer system to exert the same advantageous effects as those of the above-described disclosures.

Exemplary embodiments are described below. Note that the following exemplary embodiments do not in any way limit the scope of the content defined by the claims laid out herein. Note also that all of the elements described in the present embodiment should not necessarily be taken as essential elements.

Hereinafter, examples of embodiments of the present disclosure will be described. Note that modes to which the present disclosure is applicable are not limited to the following embodiments.

### First Embodiment

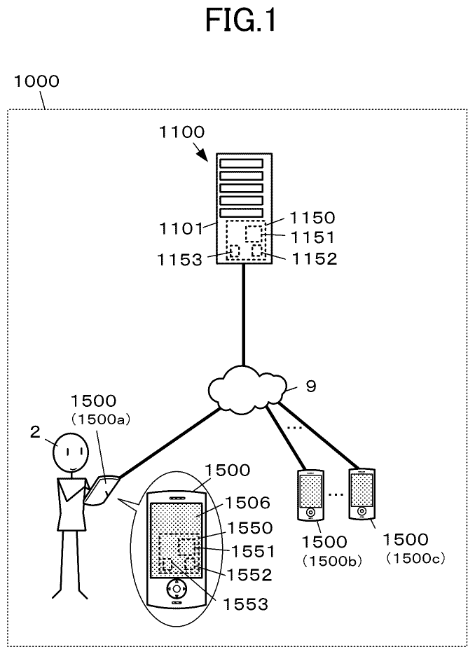

FIG. 1 is a system configuration diagram illustrating a configuration example of a game system according to the present embodiment.

A game system 1000 is a computer system for executing a given online game in which users 2, who become players, play by operating their own player characters.

The game system 1000 is a computer system including a server system 1100 and user terminals 1500 (1500a, 1500b, . . . ) for individual users, which are connected so as to be capable of data communication via a network 9. The user terminals 1500 serve as man-machine interfaces (MMIFs).

The network 9 refers to a communication channel that allows data communication. That is, examples of the network 9 include a private line (private cable) for direct coupling, a local area network (LAN) based on Ethernet (registered trademark), a telecommunication network, a cable network, the Internet, and the like.

The server system 1100 is a game server that performs various processes such as providing a predetermined registration procedure, managing information of registered users, and generating and managing various types of data for executing the game.

The server system 1100 has a control board 1150 mounted on a main body device. The control board 1150 is mounted with, for example, a microprocessor that varies in type such as a central processing unit (CPU) 1151, a graphics processing unit (GPU), or a digital signal processor (DSP), an integrated circuit (IC) memory 1152 that varies in type such as a video random access memory (VRAM), a random access memory (RAM), or a read-only memory (ROM), and a communication device 1153. The functions mounted on the control board 1150 may be implemented partially or entirely by an application specific integrated circuit (ASIC), a field-programmable gate array (FPGA), or a system on a chip (SoC).

The server system 1100 is illustrated in FIG. 1 as including only one server device. However, the server system 1100 may be implemented by a plurality of devices. For example, the server system 1100 may be configured such that a plurality of blade servers are connected together via an internal bus in a manner capable of data communication to share the functions. The server system 1100 may also include a database and online storage.

The user terminal 1500 is a computer system that is used by the user 2 to participate in an online game, and functions as a man-machine interface in the game system 1000.

The user terminal 1500 (1500a, 1500b, . . . ) is a computer system connectable to the network 9, such as a personal computer, a smartphone, a wearable computer, a portable game device, a consumer game device, or a tablet computer.

The user terminal 1500 includes an operation input device, an image display device, and a control board 1550. The operation input device can be implemented, for example, by a touch panel 1506, a keyboard, a game controller, a mouse, or the like. The image display device can be implemented, for example, by a touch panel 1506, a head-mounted display, a glass-type display, or the like.

The control board 1550 includes a microprocessor of various types such as a CPU 1551, a GPU, or a DSP, an IC memory 1552 of various types such as a VRAM, a RAM, or a ROM, a communication module 1553 that connects to the network 9. These elements mounted on the control board 1550 are electrically connected with each other via a bus circuit or the like to be capable of reading/writing data and exchange signals. The control board 1550 may be partially or entirely implemented by an ASIC, an FPGA, or an SoC.

The control board 1550 causes the IC memory 1552 to store programs and various types of data for implementing a function as the user terminal 1500. The user terminal 1500 executes a predetermined application program to implement the functions of a man-machine interface for the game system 1000 and a client for an online game.

The user terminal 1500 is configured to download programs and various types of data necessary to play a game from the server system 1100. Alternatively, the user terminal 1500 may be configured to read them from a storage medium such as a memory card obtained separately by the user.

The game in the present embodiment is a fighting game as an example. Therefore, the server system 1100 executes the fighting game. The player can select a player-versus-player (PvP) mode in which the players compete with each other, and a practice mode in which the player competes with an NPC (a control target character automatically controlled by a computer).

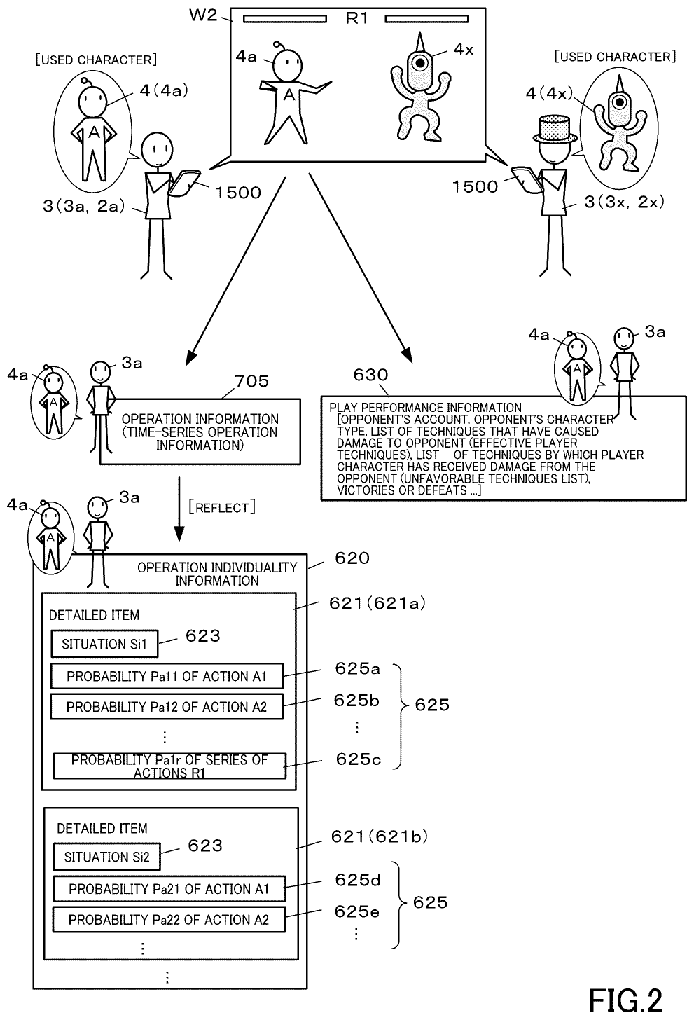

FIG. 2 is a diagram for describing various types of data stored for each user 2 who is a player 3, in association with gameplay in the PvP mode.

In the PvP mode, users 2 (2a, 2x) who are players 3 (3a, 3x) are matched with each other. Then, each of the matched players 3 plays the fighting game while viewing a game screen W2 displayed on his/her user terminal 1500.

Specifically, for example, each player 3 (3a, 3x) plays by operating a player character 4 (4a, 4x) selected from a plurality of types of candidate characters. For example, a plurality of rounds are played, with each round lasting a predetermined time. In one round, when an attack is received from an opponent, the hit point (HP) of the player character 4 that has received the attack is subtracted. When the HP reaches “0”, the player 3 of the player character 4 loses. When the time is up and one round ends, if there is no player character 4 whose HP has reached “0”, the player with the least HP at the end of the round loses. At the end of a predetermined number of rounds, the overall winner is determined based on the number of victories or defeats for each round.

Along with game progress, the server system 1100 generates and stores operation information 705 and play performance information 630 for each player 3, in association with the player 3 and the type of player character 4. The example in FIG. 2 illustrates the operation information 705 and play performance information 630 associated with the player 3a and the player character 4a. The server system 1100 also generates and stores the operation information 705 and the play performance information 630 associated with the player 3b and the player character 4x in the same manner.

The operation information 705 includes the input time and the type of operation input in association with each other in time series according to passage of time from the play start. Therefore, the operation information 705 can be said to be data that can record and reproduce the past operations of the player 3 and the past actions of the player character 4 in time series.

The play performance information 630 includes information on the results of analyzing play contents from various perspectives. Specifically, the play performance information 630 includes information on the opponent's account, the opponent's character type, a list of techniques that have caused damage to the opponent (effective player techniques list), a list of techniques by which the player character has received damage from the opponent (unfavorable techniques list), victory or defeat, and the like.

After the end of play, the server system 1100 creates or updates operation individuality information 620 of each player 3 based on the player's operation information 705 generated during the current play.

The operation individuality information 620 includes information indicating the individuality of the player 3 in the manner of performing operation inputs, in other words, the individuality of the player 3 in how the player character 4 is caused to act in various game situations that change from moment to moment. Specifically, the operation individuality information 620 is described as a gathering of a plurality of detailed items 621 (621a, 621b, . . . ). Each detailed item 621 includes a situation type 623 in the game progress and a plurality of action probabilities 625 corresponding to various action types of the player character 4.

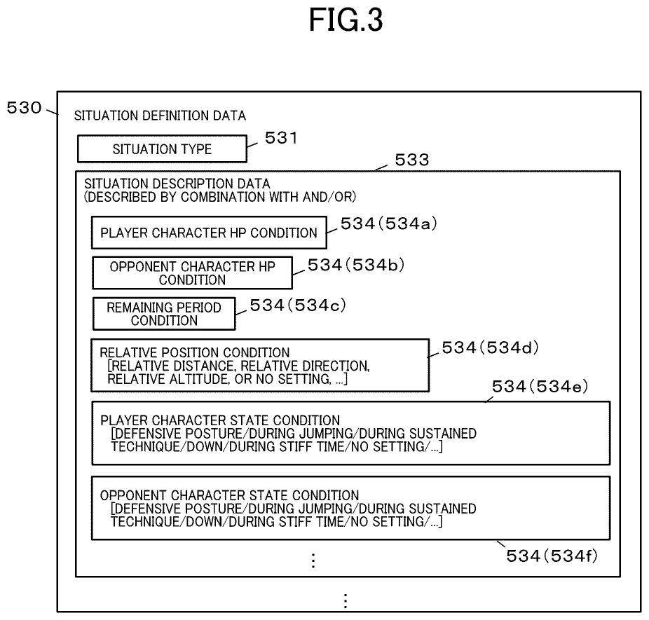

The situation type 623 is predefined by situation definition data 530 as illustrated in FIG. 3.

One piece of the situation definition data 530 can be defined using a plurality of parameters capable of defining a situation, and includes a situation type 531 and situation description data 533, for example. The situation description data 533 is described by a single detailed condition 534 for determining whether the situation is a given situation, or by combining a plurality of detailed conditions 534 with AND or OR.

The detailed conditions 534 are set as appropriate depending on the game genre and game rules, and can be defined using various parameters. In a fighting game, for example, the detailed conditions 534 may be a player character HP condition 534a, an opponent character HP condition 534b, a remaining period condition 534c, a relative position condition 534d, a player character state condition 534e, and an opponent character state condition 534f. These conditions may also be set to “no limit” or “no setting”.

The player character HP condition 534a and the opponent character HP condition 534b are described in terms of parameter ranges and thresholds related to the HP of the player character 4 and the HP of the opponent character, respectively.

The remaining period condition 534c is described in terms of a parameter range and threshold related to the remaining time of the round being played.

The relative position condition 534d is a parameter condition related to the relative position of the opponent character as seen from the player character 4, and is described by combining one or more of the range and threshold of relative distance, the range and threshold of relative direction, the range and threshold of relative altitude, and the like. Of course, this condition may not be set.

The player character state condition 534e is a parameter condition related to the state of the player character 4, and the opponent character state condition 534f is a parameter condition related to the state of the opponent character. The type of state is set as appropriate according to the game content and game rules. For example, the type of state can be a defensive posture, during jumping, during a sustained operation input to execute a technique, down, during a stiff time, no setting, or the like. During a sustained operation input means that an operation input is being performed to execute a technique that is executed by sustaining the same operation input for a certain period of time, for example. During a stiff time means a state in which an operation input is temporarily not accepted when hit by a technique.

Returning to FIG. 2, actions associated with the action probabilities 625 (625a, 625b, . . . ) include movement of the player character 4 in the game space, attack actions (e.g., punching, high kicking, middle kicking, . . . ), defensive actions (e.g., guard, sway, . . . ), use of an item, a series of actions, and the like.

A “series of actions” refers to a combination of a plurality of types of actions that appear to be executed consecutively based on a series of a plurality of operation inputs that are considered to be consecutive in time. For example, in fighting games, this would include “traps,” “combos,” and “continuous moves” that consist of a plurality of moves being performed in succession.

A series of actions may be prepared in advance by the game creator, or may be created by the player 3. A series of actions is identified in the operation information 705 as a series of a plurality of types of attack techniques that are performed continuously without any defensive action or movement operation. The combination of the attack techniques is a type of series of actions.

In the initial settings, only actions that the player character 4 can take (such as action A1, action A2, . . . in FIG. 2) are prepared as the action probabilities 625. After the end of a play, the server system 1100 analyzes the operation information 705 to recognize a series of actions, and adds a corresponding action probability 625 (in the example of FIG. 2, an action probability 625c). Specifically, after the end of a play, the server system 1100 identifies a series of actions from the operation information 705 and registers it for each player 3. Then, the action probability 625 corresponding to the series of actions is added to the detailed item 621 (in the example of FIG. 2, a detailed item 621a) of the initial situation type 623 of the series of actions (the situation in which a plurality of types of attack techniques that constitute the series of actions are used).

Therefore, it can be said that the operation individuality information 620 includes information indicating what action the player character 4 was made to take in a given game situation.

The operation individuality information 620 and the play performance information 630 are stored and managed in association with each user 2 (each player 3).

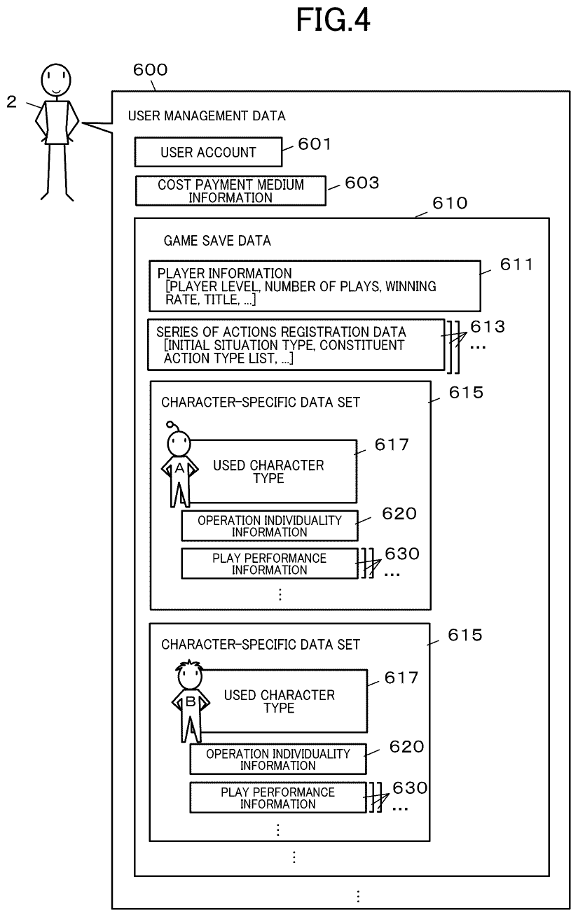

FIG. 4 is a diagram illustrating a data configuration example of user management data 600. The user management data 600 is prepared for each user 2 who has completed the registration procedure, and includes various types of information related to the user. One piece of the user management data 600 includes a user account 601, cost payment medium information 603, and game save data 610, for example. The game save data 610 includes player information 611, a series of actions registration data 613, and a character-specific data set 615. Other types of data may be included as appropriate, of course.

The cost payment medium information 603 is information on a medium that is consumed to pay various costs related to a gameplay (e.g., cost for gameplay, cost for purchasing an item, and the like). The cost payment medium can be selected as appropriate from points awarded in relation to gameplay, parameter values such as experience values, items, virtual currency, and the like, for example. The cost payment medium information 603 indicates the owned balance of the cost payment medium.

The player information 611 includes information such as a player level which is automatically given according to play performance, number of plays, winning rate, title, ranking, and the like.

The series of actions registration data 613 is prepared for each type of series of actions. One piece of the series of actions registration data 613 includes an initial situation type and a constituent action type list in which the action types constituting the series of actions are arranged in sequential order.

The character-specific data set 615 is prepared for each type of character used as the player character 4. One piece of the character-specific data set 615 has a used character type 617, operation individuality information 620 with the use of a character of the used character type 617, and play performance information 630 with the use of a character of the used character type 617.

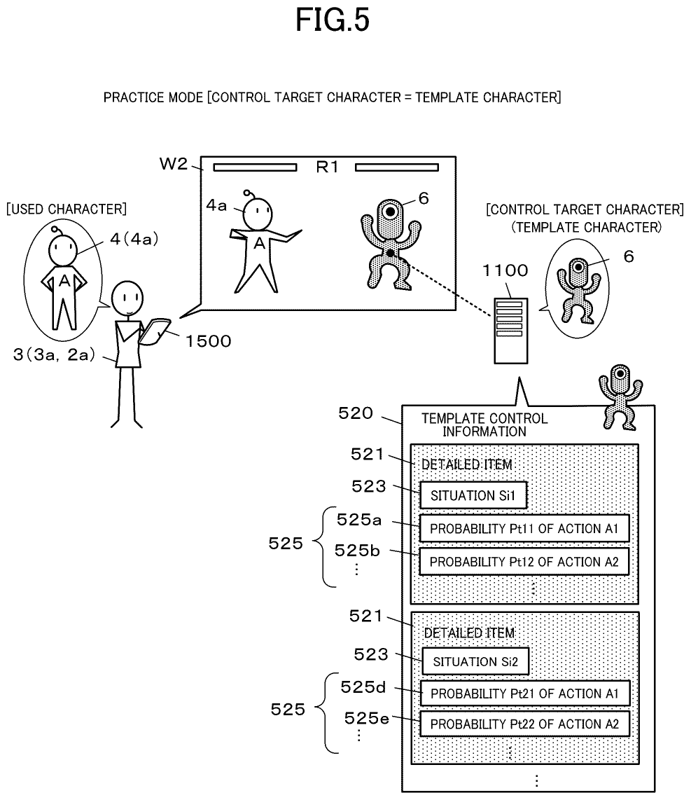

FIG. 5 is a diagram for describing automatic control in a case where a template character is selected as the control target character 6 in the practice mode.

In the practice mode, the player 3 operates his/her own player character 4 to compete with the control target character 6, which is an NPC. Before play start, the player 3 can select whether the control target character 6 should be a template character prepared in advance by the game creator as an NPC, or a ghost character that requires cost payment.

If the control target character 6 is a template character, the server system 1100 selects the control target character 6 from among candidate characters that can be the player character 4. Then, from a plurality of types of template control information 520 prepared in advance, the server system 1100 automatically controls the control target character 6 using the template control information 520 corresponding to the type of the selected candidate character.

The template control information 520 is prepared for each character type of candidate characters, and is information that determines the thinking patterns, action patterns, and operation tendency patterns of a character AI. The template control information 520 has the same data structure as the operation individuality information 620. In other words, the server system 1100 searches the used template control information 520 for the detailed items 521 of the situation types 523 that match the situation that changes from moment to moment during game progress. Then, the server system 1100 performs an action determination lottery to which the action probabilities 525 of the searched detailed items 521 are applied, thereby determining the action type of the control target character 6 at that time.

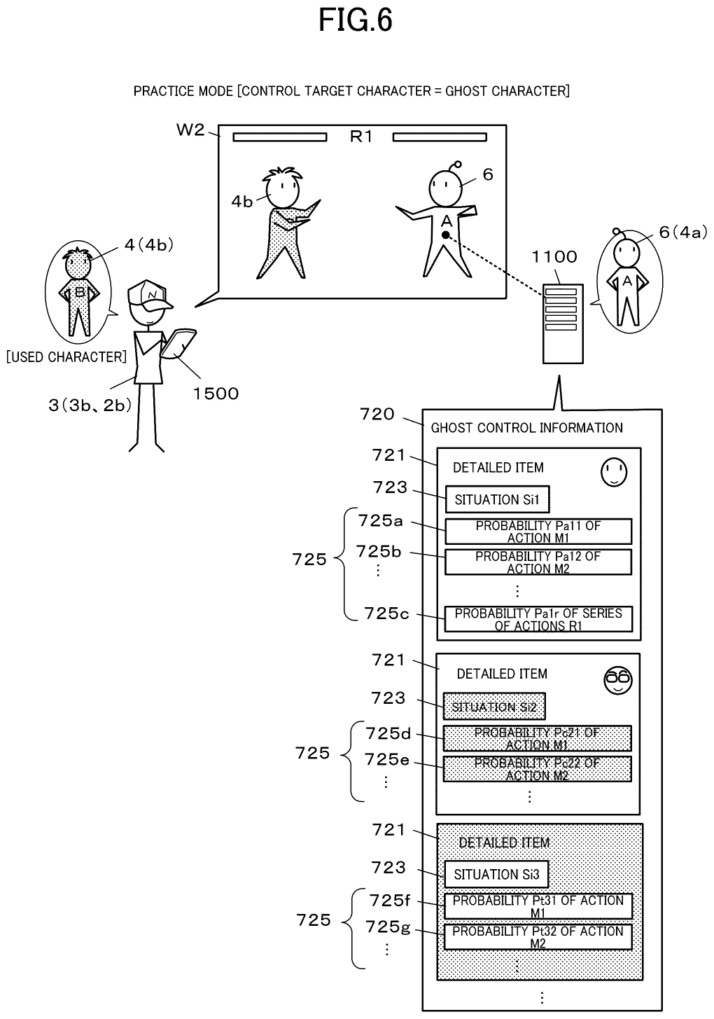

FIG. 6 is a diagram for describing automatic control in a case where a ghost character is selected as the control target character 6 in the practice mode.

If the control target character 6 is a ghost character, the server system 1100 selects the control target character 6 from among candidate characters that can be the player character 4 and automatically controls the control target character 6 using ghost control information 720.

The ghost control information 720 is information that determines the thinking patterns, action patterns, and operation tendency patterns of the character AI, and has the same data structure as the operation individuality information 620. That is, the server system 1100 searches the ghost control information 720 for detailed items 721 of a situation type 723 that matches the situation that changes from moment to moment during game progress. Then, the server system 1100 performs an action determination lottery to which action probabilities 725 of the searched detailed items 721 are applied, thereby determining the action type of the control target character 6 at that time.

The ghost control information 720 is generated based on the operation individuality information 620 of a plurality of “selection players” selected from among the opponent players (other users) other than the player 3.

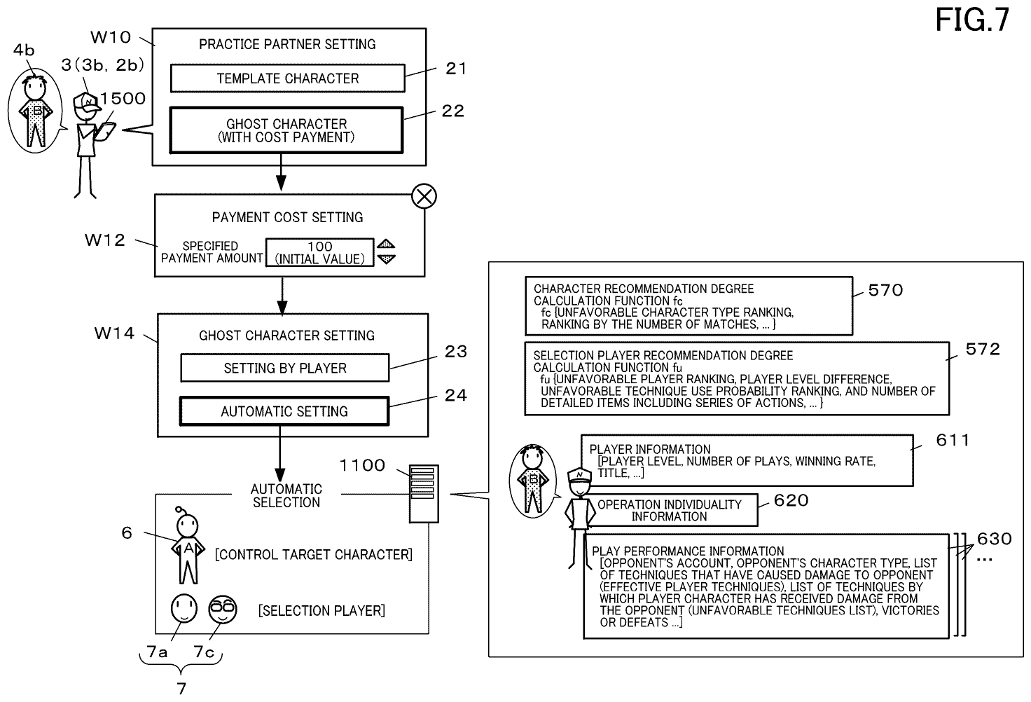

FIG. 7 is a diagram for describing a display example of a setting screen in the practice mode, selection of a control target character to be used as a ghost character, and selection of the selection player 7.

In the example of FIG. 7, the user 2b, who is the player 3 (3b), selects the player character 4b from among candidate characters and selects the “practice mode” as the game mode. A setting screen W10 for the practice mode is displayed on the user terminal 1500. Displayed on the setting screen W10 are a first operation icon 21 in which the control target character 6, who is a practice partner, is used as a template character, and a second operation icon 22 in which the control target character 6 is used as a ghost character. The player 3 selects and inputs one of these.

If the first operation icon 21 is selected, the server system 1100 displays a list of candidate characters on the user terminal 1500 and accepts a selection operation by the player 3 of the character type to be the control target character 6.

If the second operation icon 22 is selected, the server system 1100 displays a setting screen W12 on the user terminal 1500. The setting screen W12 accepts a setting operation by the player 3 regarding the amount of the cost to be paid for using a ghost character. The initial setting value is a predetermined full amount of “100”, but the player 3 can reduce the amount and set the amount of the cost lower than the initial setting value. However, if the cost is equal to the initial setting value, the ghost character is automatically controlled 100% based on the operation individuality information 620 of other users. If the cost is less than the initial setting value, the template control information 520 is used for part of the automatic control of the ghost character. That is, the degree of automatic control of the ghost character changes depending on the amount of the cost.

Upon receipt of the setting operation of the cost payment amount, the server system 1100 displays a setting screen W14 on the user terminal 1500. On the setting screen W14, a third operation icon 23 and a fourth operation icon 24 are displayed.

If the third operation icon 23 is selected, the server system 1100 displays a list of candidate characters on the user terminal 1500 and accepts a selection operation by the player 3 of the character type of the control target character 6. The server system 1100 also displays a list of accounts of the selection candidate users of the selection player 7 or an account input field and accepts a selection operation by the player 3 of a plurality of selection players 7.

If the fourth operation icon 24 is selected, the server system 1100 automatically selects the type of the control target character 6 to be the ghost character, and also automatically selects a plurality of selection players 7 (7a, 7c).

In order to automatically select the type of the control target character 6 to be the ghost character, the server system 1100 calculates a recommendation degree for each type of character that is a candidate for the player character 4 based on a character recommendation degree calculation function 570. Then, the server system 1100 selects the type of the candidate character with the highest recommendation degree as the type of the control target character 6 to be the ghost character.

The character recommendation degree calculation function 570 is a function that uses, as variables, information related to the play performance information 630 of the player 3, such as the unfavorable character type ranking and the ranking by the number of matches. The unfavorable character type ranking is the ranking determined by referring to all the play performance information 630 of the player 3 and ranking each character type by the victory or defeat rate in ascending order. The number of matches is a cumulative total of the number of times the player 3 has previously competed with a character of the type as an opponent. One of the variables of the character recommendation degree calculation function 570 may be omitted, or another variable may be added. The character recommendation degree calculation function 570 may also be table data.

In order to automatically select a plurality of selection players 7, the server system 1100 calculates the recommendation degree for each player other than the player 3 based on a selection player recommendation degree calculation function 572, and sets a given number of opponent players with the higher recommendation degrees as the selection players 7. The number of selection players 7 is basically two, but may be three or more.

The selection player recommendation degree calculation function 572 is a function that uses, as variables, information related to the play performance information 630 of the player 3, and the like. The information related to the play performance information 630 is the unfavorable player ranking, the player level difference, the ranking of the use frequency of unfavorable techniques, and the number of detailed items 621 including the action probabilities 625 corresponding to a series of actions (the number of detailed items including a series of actions), for example.

The unfavorable player ranking is the ranking determined by referring to all the play performance information 630 of the player 3 and ranking the other users 2 who have been opponents by the victory or defeat rate in ascending order.

The player level difference is the difference in player level between the player and the opponent. In order to determine the player level difference, the player information 611 of the player is referred to as appropriate. The ranking of the use frequency of unfavorable techniques is the ranking of the other users 2 in order of the action probability 725 (see FIG. 2) using the list of unfavorable techniques in all the play performance information 630 of the player 3.

One or more of the variables of the selection player recommendation degree calculation function 572 may be omitted, or another variable may be added. The selection player recommendation degree calculation function 572 may be table data.

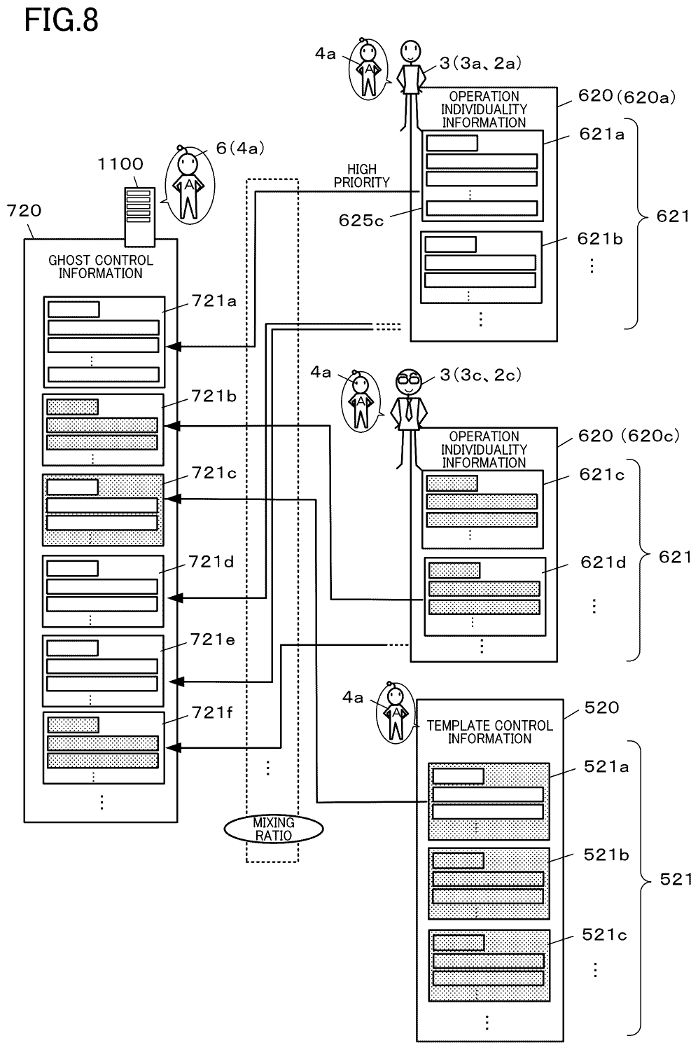

FIG. 8 is a diagram for describing generation of the ghost control information 720.

The ghost control information 720 is generated based on:
(1) the operation individuality information 620 (620a, 620c) in a case where a candidate character of the same type as the control target character 6 (4a), which is a ghost character of the plurality of selection players 7 (7a, 7c), is used as the player character 4 (4a); and
(2) the template control information 520 for a candidate character of the same type as the control target character 6 (4a), which is a ghost character.

Specifically, for each of the detailed items 721 (721a, 721b, 721c, . . . ) in the ghost control information 720, the detailed items 621 in the operation individuality information 620 (620a, 620c) of the plurality of selection players 7 (7a, 7c) and the detailed items 521 in the template control information 520, which have the same situation type as the situation type 723 are extracted. Then, one of the extracted detailed items 621 and detailed items 521 is selected and copied, and set as the detailed items 721.

In the example of FIG. 8, the detailed item 621a of the operation individuality information 620a is selected and set for the first detailed item 721a. The detailed item 621d of the individuality information 620b is selected and set for the second detailed item 721b. The detailed item 521a of the template control information 520 is selected and set for the third detailed item 721c.

However, regardless of the situation type, the detailed items 621 including the action probability 625 of a series of actions (see FIG. 2; action probability 625c) is preferentially selected. In the example of FIG. 8, the server system 1100 preferentially selects the detailed item 621a including the action probability 625c of a series of actions for the first detailed item 721a.

That is, the server system 1100 generates the ghost control information 720 by mixing a plurality of pieces of operation individuality information 620 and template control information 520 for each of the detailed items 621 and 521.

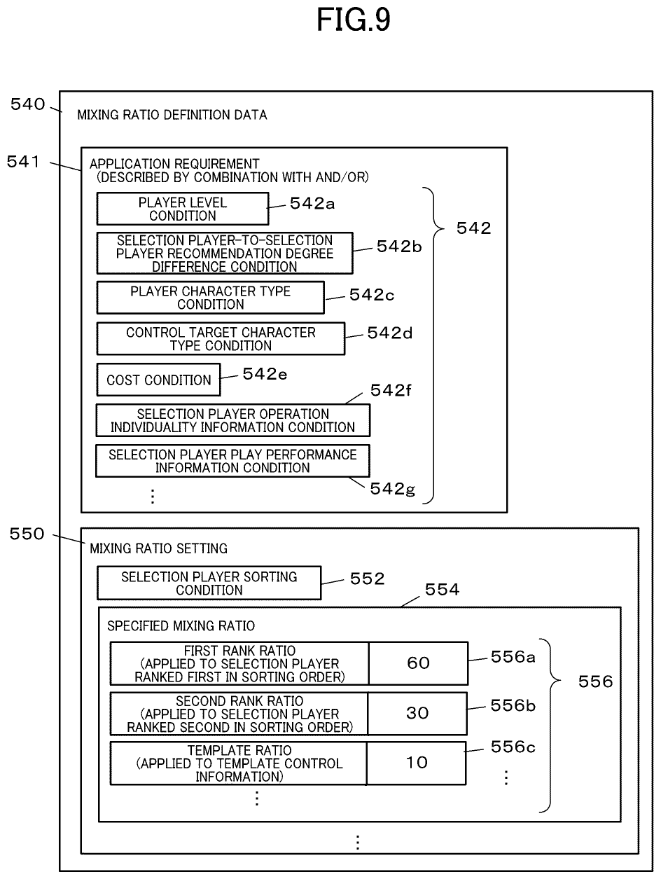

The ratio (mixing ratio) of the plurality of pieces of operation individuality information 620 (620a, 620c) and the template control information 520 for each detailed item 621 and each detailed item 521 is set as appropriate according to the situation at each time with reference to mixing ratio definition data 540 illustrated in FIG. 9.

FIG. 9 is a diagram illustrating a data configuration example of mixing ratio definition data 540.

A plurality of types of mixing ratio definition data 540 having different conditions are prepared in advance. One piece of the mixing ratio definition data 540 includes an application requirement 541 for selecting and applying the definition data, and a mixing ratio setting 550.

The application requirement 541 is described by combining one detailed condition 542 or a plurality of detailed conditions 542 with AND or OR.

The detailed conditions 542 may include a player level condition 542a, a selection player-to-selection player recommendation degree condition 542b, a player character type condition 542c, and a control target character type condition 542d, for example. In addition, the detailed condition 542 may include a cost condition 542e, a selection player operation individuality information condition 542f, and a selection player play performance information condition 542g.

The player level condition 542a is a condition that must be satisfied for the player level of the player 3, and is described as a level range, a threshold, or no setting.

The selection player-to-selection player recommendation degree condition 542b is a condition that must be satisfied regarding the difference between the recommendation degrees (values calculated using the selection player recommendation degree calculation function 572; see FIG. 5) determined at the time of selecting a plurality of selection players 7, and is described as a range of recommendation degrees, a threshold, or no setting.

Depending on the selection of the plurality of selection players 7, the difference in skill and experience may become large or small, and the compatibility with the player 3 may change, which is expressed as the recommendation degree for each selection player 7. Therefore, setting the selection player-to-selection player recommendation degree condition 542b as appropriate makes it possible to set separately the mixing ratio definition data 540 to be applied when a plurality of selection players 7 having the same compatibility with the player 3 and the mixing ratio definition data 540 to be applied when a plurality of selection players 7 having different compatibilities are selected, for example.

The player character type condition 542c is a condition that must be satisfied for the character type of the player character 4, and is described as a character type, no setting, or the like.

The control target character type condition 542d is a condition that must be satisfied for the character type of the control target character 6, and is described as a character type, no setting, or the like. Providing different settings for the control target character type condition 542d makes it possible to separate the applied mixing ratio definition data 540 between the case where the control target character 6 is a character that the player 3 had difficulty playing with when using the player character 4, and the case where the control target character 6 is a character that the player 3 was good at playing with.

The cost condition 542e is a condition that must be satisfied for the payment of the cost for use of the ghost character, and is described as a cost range, a threshold, no setting, or the like. Specifically, the cost condition 542e is determined by the payment cost setting amount input on the setting screen W12 (see FIG. 7).

The selection player operation individuality information condition 542f is a condition that must be satisfied for any one or more pieces of the operation individuality information 620 of the selection players 7. For example, the condition may be described as a difference between a statistics value (e.g., average value, median value, maximum value, minimum value, range, or the like) of the action probability 625 corresponding to an attack action among all the action probabilities 625 and a statistics value of the action probability 625 corresponding to a defensive action. In this case, preparing different settings for the selection player operation individuality information condition 542f makes it possible to separate the mixing ratio definition data 540 in the case of showing an offensive operation tendency and the mixing ratio definition data 540 in the case of showing a defensive operation tendency, for example.

The selection player play performance information condition 542g is a condition that must be satisfied for any one or more pieces of the play performance information 630 of the selection players 7. For example, the condition may be set as to whether the selection player 7 has an effective player technique that is an unfavorable technique for the player 3, or whether the selection player 7 has a winning record against the player 3.

Note that one or more of these detailed conditions 542 may be omitted, or other detailed conditions 542 may be used. Also, one or more of the detailed conditions 542 may be set to “no setting” or “no restriction”.

The mixing ratio setting 550 specifies the mixing ratio. The mixing ratio setting 550 includes a selection player sorting condition 552 and a specified mixing ratio 554.

The selection player sorting condition 552 specifies a sorting condition for sorting a plurality of selection players 7. The sorting condition is described using the player level, the recommendation degree set when selecting the selection player, the player history, and the like, for example.

The specified mixing ratio 554 includes, in a predetermined order, a predetermined number (the same number as the number of selection players 7) of ratios 556 (556a, 556b) applied to the selection players 7 of upper ranks in the sorting order and a ratio 556 (556c) applied to the template control information 520.

The example in FIG. 9 is a setting example in a case where two selection players 7 are selected. Three ratios are included in a predetermined order: the first rank ratio 556a applied to the selection player 7 ranked first in the sorting order, the second rank ratio 556b applied to the selection player 7 ranked second in the sorting order, and the template ratio 556c applied to the template control information 520. The numeric values for the first rank ratio 556a, the second rank ratio 556b, and the template ratio 556c are shown as percentages in FIG. 9. In a configuration in which three selection players 7 are selected, the specified mixing ratio 554 will include a third rank ratio 556.

The ratio 556 applied to the template control information 520 (template ratio 556c in the example in FIG. 9) is set such that the larger the cost specified in the cost condition 542e, the smaller the ratio. For example, if the cost condition 542e is “player 3 pays 100% of the cost”, the template ratio 556c is “0”.

There may be the mixing ratio definition data 540 in which any ratio 556 of the specified mixing ratios 554 is “0”. There may also be the mixing ratio definition data 540 in which any ratio 556 of the specified mixing ratios 554 is “100”.

Also, for some or all pieces of the mixing ratio definition data 540, the template ratio 556c may be set to “0”, and the other ratios such as the first rank ratio 556a, the second rank ratio 556b, . . . may be set to be equal to each other. In other words, there may be a setting in which the operation individualities of a plurality of selection players 7 are averaged.

When generating the ghost control information 720, the server system 1100 searches the mixing ratio definition data 540 for definition data that satisfies the application requirements 541, and determines the mixing ratio to be applied according to the mixing ratio setting 550. That is, the server system 1100 determines the sorting ranks of the selection players 7 in the selection player sorting condition 552, and adopts the ratio for each rank in the specified mixing ratio 554.

Next, a functional configuration will be described.

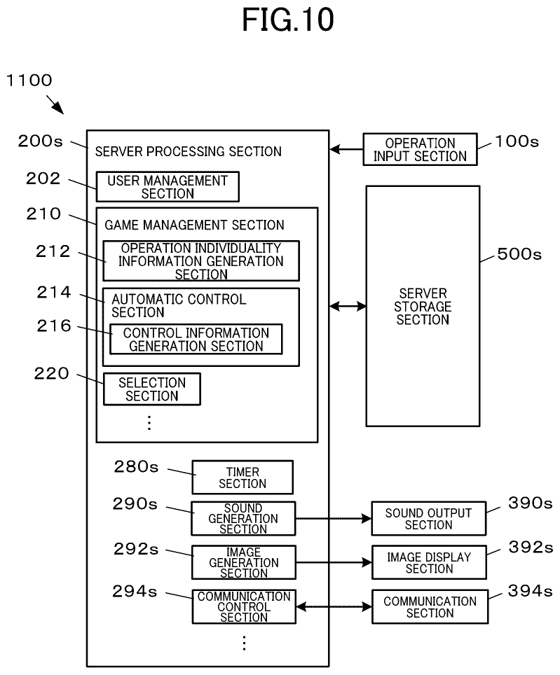

FIG. 10 is a block diagram illustrating an example of a functional configuration of the server system 1100.

The server system 1100 includes an operation input section 100s, a server processing section 200s, a sound output section 390s, an image display section 392s, a communication section 394s, and a server storage section 500s.

The operation input section 100s is a means for inputting various operations for management of the server system 1100. For example, the operation input section 100s is a keyboard, a touch panel, a mouse, or the like.

The server processing section 200s is implemented, for example, by a processor that is a calculation circuit such as a CPU, a GPU, an ASIC, or an FPGA and an electronic component such as an IC memory. The server processing section 200s performs input/output control of data to/from functional sections including the operation input section 100s and the server storage section 500s. The server processing section 200s performs various calculation processes based on predetermined programs and data, and data of operation input signals from the operation input section 100s, or the like to entirely control the operation of the server system 1100.

The server processing section 200s has a user management section 202, a game management section 210, a timer section 280s, a sound generation section 290s, an image generation section 292s, and a communication control section 294s.

The user management section 202 performs a process related to a user registration procedure of the game system 1000, and stores and manages various types of information associated with a user account.

The game management section 210 performs various types of control related to game execution. Specifically, the game management section 210 sets up a game space by arranging background objects in a virtual three-dimensional space, arranges characters such as the player character 4 in the game space, and controls their actions in response to operation inputs by the player 3. The game management section 210 also performs automatic control of NPCs.

The game management section 210 includes an operation individuality information generation section 212, an automatic control section 214, and a selection section 220.

The operation individuality information generation section 212 generates the operation individuality information 620 for each player 3 based on the operation information 705 of the player character 4 by the player (see FIG. 2). Specifically, the operation individuality information generation section 212 generates the operation individuality information 620 for each of a plurality of types of characters (for each type of candidate character that the player can select and use as the player character 4) based on the operation information 705 in a case where the character is set as the player character 4 (see FIG. 4; character-specific data set 615).

The automatic control section 214 automatically controls a given control target character 6 based on the operation individuality information 620 of a plurality of selection players 7.

Specifically, the automatic control section 214 has a control information generation section 216. The control information generation section 216 generates control information (ghost control information 720) to be used for automatically controlling the control target character 6, based on, among the operation individuality information 620 of the plurality of selection players 7, the operation individuality information 620 in a case where a character corresponding to the type of the control target character 6 is set as the player character 4 (see FIG. 4). Then, the control information is used to automatically control the control target character 6 (see FIG. 6).

More specifically, the automatic control section 214 performs automatic control in response to a request operation (operation on the second operation icon 22 in FIG. 7) of a player (player 3 in FIG. 7) who desires automatic control, and performs cost collection control to collect a given cost from the player who desires automatic control (see the setting screen W12 in FIG. 7). The automatic control section 214 then changes the degree of automatic control of the control target character 6 based on the amount of the cost.

The control information generation section 216 generates the detailed items 721 by selecting, for each detailed item 621 of the operation individuality information 620, the operation individuality information 620 of the selection player 7 to be adopted as detailed items 721 of the control information (ghost control information 720) to be used for automatic control of the control target character 6 (see FIG. 8).

The control information generation section 216 selects the operation individuality information 620 of the selection player 7 to be adopted for each of the detailed items 621 so as to achieve a given ratio among the players.

The control information generation section 216 further determines which selection player 7 to adopt from among the plurality of selection players 7 for each detailed item 621, based on the operation individuality information 620 of the selection players 7. Specifically, based on the information included in the operation individuality information 620 and play performance information 630 of the selection player 7, the control information generation section 216 calculates the recommendation degrees using the selection player recommendation degree calculation function 572, and selects the selection players 7 based on the ranking of recommendation degree (see FIG. 7).

The selection section 220 selects the selection player based on an operation input of the player who desires automatic control (operation input to the third operation icon 23 in FIG. 7).

The selection section 220 also selects the selection player 7 based on the play performance information 630 of the player who desires automatic control (the player 3 in FIG. 7).

The timer section 280s uses a system clock to measure various times such as the current date and time and limited time periods.

The sound generation section 290s is implemented by executing an IC or software that generates and decodes sound data. The sound generation section 290s outputs generated sound signals to the sound output section 390s. The sound output section 390s is implemented by a speaker or the like, and emits sounds based on the sound signals.

The image generation section 292s generates images of various management screens for the system management of the server system 1100, and outputs image data to the image display section 392s. The image generation section 292s also generates some or all of the images to be displayed on the user terminal 1500. The image display section 392s is implemented by a device for displaying images such as a flat panel display, a head-mounted display, or a projector.

The communication control section 294s performs data processing related to data communication, and implements data exchange with an external device through the communication section 394s. The communication section 394s connects to the network 9 to implement communication. For example, the communication section 394s is implemented by a wireless communication device, a modem, a terminal adaptor (TA), a jack for wired communication cable, or a control circuit. In the example illustrated in FIG. 1, the communication device 1153 corresponds to the communication section 394s.

The server storage section 500s stores programs and various types of data for implementing various functions for causing the server processing section 200s to comprehensively control the server system 1100. The server storage section 500s is used as a work area for the server processing section 200s, and temporarily stores results of calculations executed by the server processing section 200s in accordance with the various types of programs. These functions are implemented, for example, by an IC memory such as a RAM or a ROM, a magnetic disc such as a hard disk, an optical disc such as a CD-ROM or a DVD, or an online storage. In the example of FIG. 1, storage media such as the IC memory 1152 mounted in the server system 1100 and hard disks correspond to the server storage section 500s.

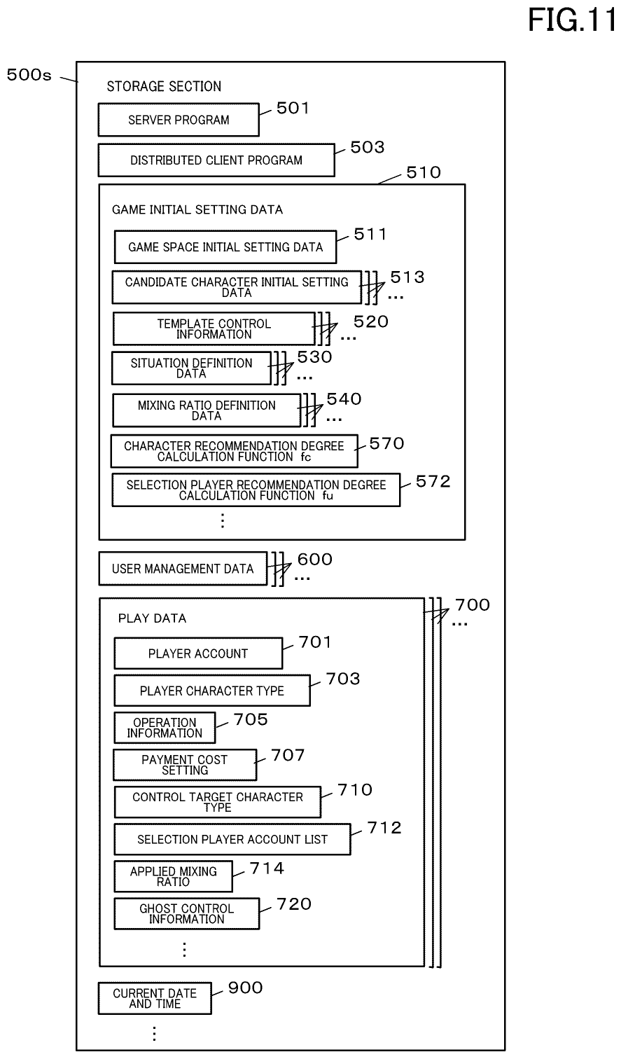

FIG. 11 is a diagram illustrating an example of the programs and data stored in the server storage section 500s.

The server storage section 500s stores a server program 501 and a distributed client program 503. The server storage section 500s also stores game initial setting data 510, user management data 600 (see FIG. 4), play data 700, and current date and time 900. The server storage section 500s also stores other programs and data (e.g., a timer, a counter, and various flags) as appropriate.

The server program 501 is a program for implementing functions of the user management section 202 and the game management section 210.

The distributed client program 503 is an original client program provided to the user terminal 1500 and executed therein.

The game initial setting data 510 stores various types of initial setting data related to the game.

The game initial setting data 510 includes game space initial setting data 511, candidate character initial setting data 513, the template control information 520 (see FIG. 5), and the situation definition data 530 (see FIG. 3), for example. The game initial setting data 510 also includes the mixing ratio definition data 540 (see FIG. 9), the character recommendation degree calculation function 570 (see FIG. 7), and the selection player recommendation degree calculation function 572 (see FIG. 7). Other types of data may be included as appropriate, of course.

The candidate character initial setting data 513 is prepared for each type of candidate character that is an option for the player character 4 and the control target character 6. One piece of the candidate character initial setting data 513 stores various types of information such as the character type, template control information ID to be used, action data for executing various techniques, ability parameter values of the techniques, and stiff time settings.

The play data 700 is created for each gameplay, and stores various types of data related to the game progress control of that gameplay.

One piece of the play data 700 includes a player account 701 indicating the user 2 who is the player 3, a player character type 703 indicating the type of candidate character to be used as the player character 4, and the operation information 705 (see FIG. 2), for example.

Although FIG. 11 illustrates one each of the above-described types of information, but these types of information are prepared for the number of players according to the play mode. That is, in the practice mode, one player practices against the control target character 6, so that the information is prepared for one player. In the PvP mode, a one-on-one match is played, so that the information is prepared for two players.

Moreover, one piece of the play data 700 includes a payment cost setting 707 (amount accepted on the setting screen W12 in FIG. 7) and a control target character type 710 which is the type of the candidate character selected as the control target character 6. One piece of the play data 700 also includes a selection player account list 712 which indicates a plurality of users 2 selected as the selection players 7, an applied mixing ratio 714, and the ghost control information 720 (see FIG. 6). Of course, the play data 700 can include other data as appropriate.

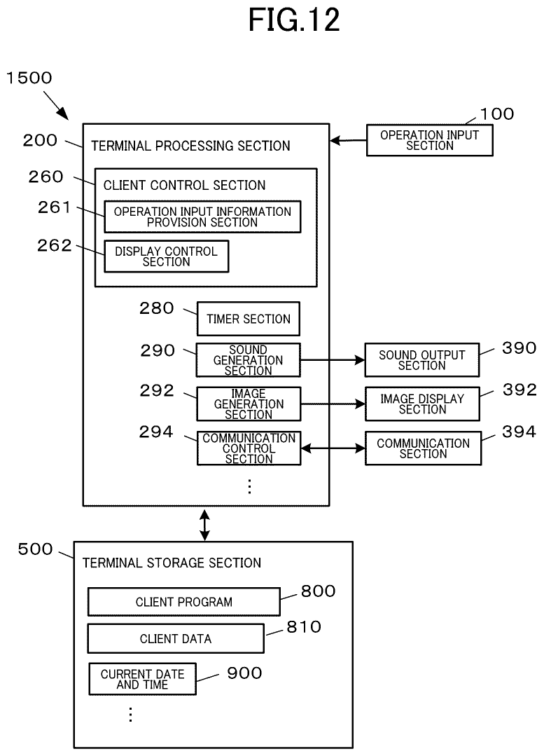

FIG. 12 is a functional block diagram illustrating a functional configuration example of the user terminal 1500. The user terminal 1500 includes an operation input section 100, a terminal processing section 200, a sound output section 390, an image display section 392, a communication section 394, and a terminal storage section 500.

The operation input section 100 outputs operation input signals according to various types of operation inputs made by the user 2, who is the player 3, to the terminal processing section 200. The operation input section 100 can be implemented, for example, by a push switch, a touch panel, a joystick, a touch pad, a track ball, an accelerometer, or a gyro.

The terminal processing section 200 is implemented, for example, by a microprocessor such as a CPU or a GPU, and electronic components such as an IC memory. The terminal processing section 200 controls data input/output to/from the functional sections including the operation input section 100 and the terminal storage section 500. The terminal processing section 200 executes various calculation processes based on a predetermined program or data, operation input signals from the operation input section 100, and various types of data received from the server system 1100 to control the operation of the user terminal 1500.

The terminal processing section 200 includes a client control section 260, a timer section 280, a sound generation section 290, an image generation section 292, and a communication control section 294.

The client control section 260 performs various type of control to cause the user terminal 1500 to function as a man-machine interface (MMIF) for control by a client in the game system 1000. Specifically, the client control section 260 includes an operation input information provision section 261 and a display control section 262.

The operation input information provision section 261 performs control for sending operation input information to the server system 1100 according to the input from the operation input section 100.

The display control section 262 performs control for displaying various images based on the data received from the server system 1100.

The timer section 280 uses a system clock to measure the current date and time, limited time periods, or the like.

The sound generation section 290 is implemented, for example, by a processor such as a digital signal processor (DSP) or a sound synthesizing IC, or an audio codec for playing a sound file. The sound generation section 290 generates sound signals for music, sound effects, or various types of operational sounds and outputs the signals to the sound output section 390. The sound output section 390 is implemented by a device that outputs sound (emits sound) based on the sound signals input from the sound generation section 290, such as a speaker.

The image generation section 292 generates and outputs an image signal for displaying an image on the image display section 392 under the control of the client control section 260. In the example of FIG. 1, a graphics processing unit (GPU), a graphic controller, or a graphic board mounted on the control board 1550 corresponds to the image generation section 292. The image display section 392 is implemented by a device for displaying images such as a flat panel display, a head-mounted display, or a projector.

The communication control section 294 performs data processing related to data communication, and implements data exchange with an external device through the communication section 394.

The communication section 394 connects to the network 9 to implement communication.

For example, the communication section 394s is implemented by a wireless communication device, a modem, a terminal adaptor (TA), a jack for wired communication cable, or a control circuit. In the example of FIG. 1, the communication module 1553 corresponds to the communication section 394.

The terminal storage section 500 stores programs and various types of data for causing the terminal processing section 200 to implement given functions. The terminal storage section 500 is also used as a work area for the terminal processing section 200, and temporarily stores results of calculations executed by the terminal processing section 200 in accordance with various programs, input data input from the operation input section 100, or the like. These functions are implemented, for example, by an IC memory such as a RAM or a ROM, a magnetic disk such as a hard disk, or an optical disk such as a CD-ROM or a DVD. In the example of FIG. 1, the IC memory 1552 mounted on the control board 1550 corresponds to the terminal storage section 500.

Specifically, the terminal storage section 500 stores a client program 800 (application program) for causing the user terminal 1500 to function as the client control section 260 for the virtual space service, client data 810, and the current date and time 900. Of course, the terminal storage section 500 can also store other data as appropriate.

The client data 810 is various types of data with which the client control section 260 executes control. The client data 810 includes a user account, a password, and the like, for example.

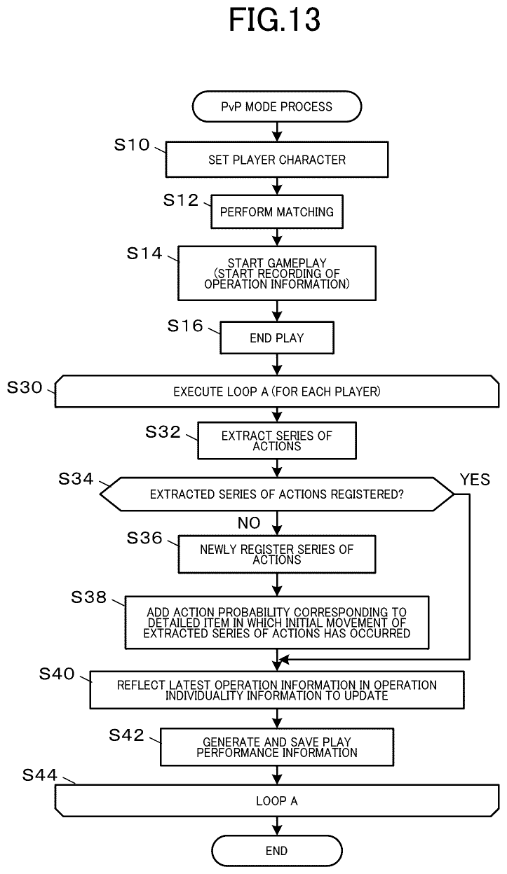

FIG. 13 is a flowchart for describing the flow of a PvP mode process.

The PvP mode process is executed when the player 3 selects the PvP mode.

In the PvP mode process, the server system 1100 sets the player character 4 to be operated by the player 3 (step S10). The server system 1100 displays a list of candidate characters on the user terminal 1500 and accepts a selection operation, for example.

The server system 1100 then matches a plurality of players 3 to compete with each other (step S12), and starts gameplay (step S14). At the start of gameplay, the server system 1100 starts recording the operation information 705 for each player 3 (see FIG. 2).

At the end of play (step S16), the server system 1100 executes loop A for each player 3 (steps S30 to S44).

In the loop A, the server system 1100 extracts a series of actions from the operation information 705 of the processing target player (step S32). Specifically, the server system 1100 extracts a group of attack actions that are continuously input at the timing of operation, and statistically processes the frequency of appearance of each combination of attack actions. If the frequency of appearance reaches a predetermined criterion, the server system 1100 deems the group of continuous attack actions not to be a coincidence, but to have been performed by the player 3 as a trap or combo. The server system 1100 then deems the group of continuous attack actions to be a series of actions. Of course, a series of actions may be extracted in a manner other than the above.

The server system 1100 then refers to the series of actions registration data 613 (see FIG. 4) to determine whether the series of actions extracted this time has been registered. If it has not been registered (NO in step S34), the server system 1100 creates and registers a new series of actions registration data 613 (step S36). The server system 1100 then adds the action probability 625 corresponding to the extracted series of actions to the detailed item 621 in which the initial movement of the extracted series of actions has occurred, among the operation individuality information 620 of the processing target player (step S38).

The server system 1100 then reflects the operation information 705 of the processing target player in the operation individuality information 620 of the processing target player for updating (step S40). In addition, the server system 1100 generates and saves the play performance information 630 (see FIG. 2) related to the current PvP play (step S42), and ends the loop A (step S44). After execution of the loop A for all the players 3 in the gameplay, the server system 1100 ends the PvP mode process.

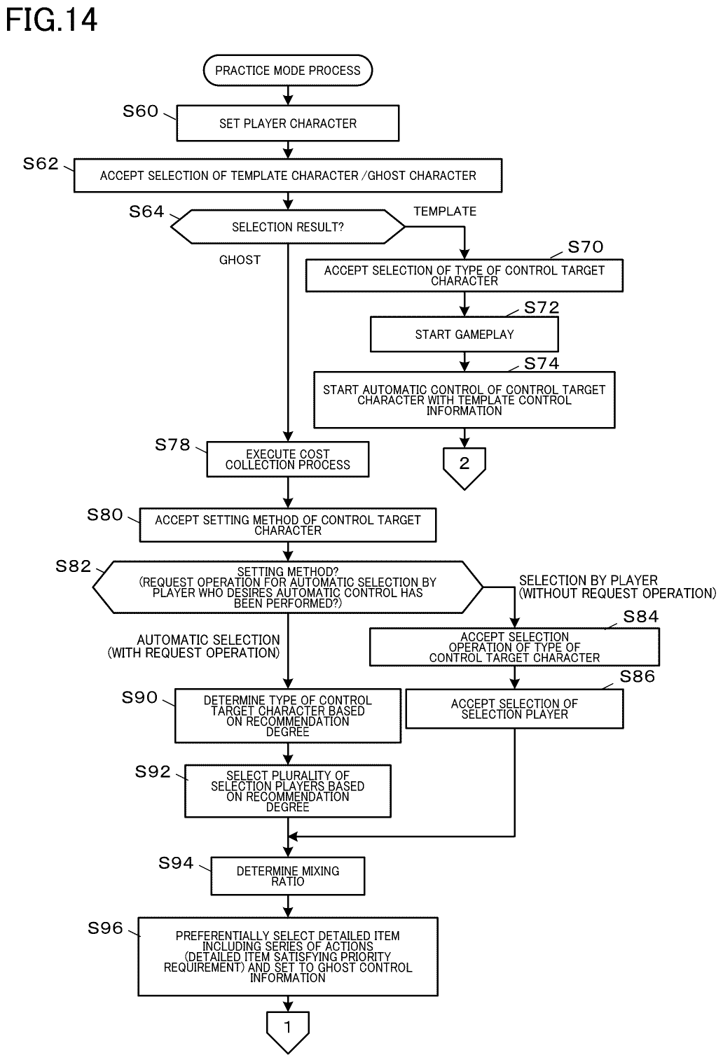

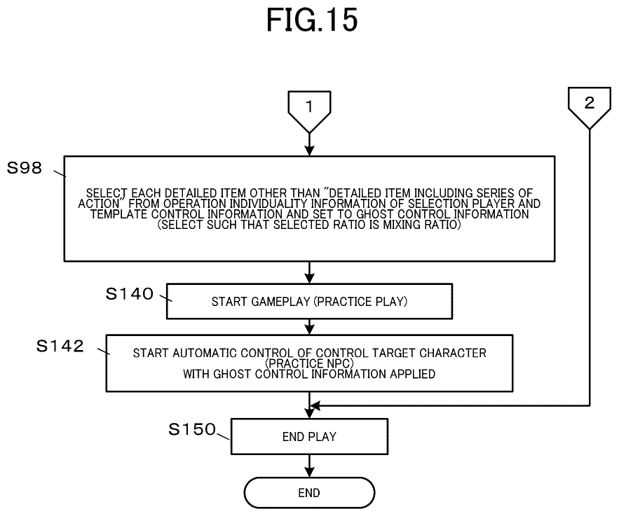

FIGS. 14 and 15 are flowcharts for describing the flow of the practice mode process.

The practice mode process is executed when the player 3 selects the practice mode.

In the practice mode process, the server system 1100 first sets the player character 4 (step S60). Then, the server system 1100 displays the setting screen W10 (see FIG. 7) on the user terminal 1500, and accepts a selection operation of whether to use a template character or a ghost character as the control target character 6, which is the practice partner NPC (step S62).

If a template character is selected (template in step S64), the server system 1100 accepts a selection operation for the type of the control target character 6 (step S70). That is, the server system 1100 displays a list of candidate characters on the user terminal 1500, and accepts a selection of the type of candidate character to be used as a practice partner NPC.

The server system 1100 then starts gameplay (step S72), applies the template control information 520 (see FIG. 5) that is suitable for the character type of the control target character 6, and starts automatic control of the control target character 6 (step S74).

On the other hand, if a ghost character is selected (ghost in step S64), the server system 1100 executes a cost collection process (step S78). That is, the server system 1100 displays the setting screen W12 (see FIG. 7) on the user terminal 1500 and accepts the setting of the payment cost.

Next, the server system 1100 displays the setting screen W14 (see FIG. 7) on the user terminal 1500, and accepts one of the setting method in which the control target character 6 to be a ghost character is selected and set by the player 3 and the method in which the control target character 6 is set automatically (step S80).

If the third operation icon 23 is selected, the server system 1100 deems that “player selection” has been selected as the setting method (player selection in step S82), and displays a list of candidate characters on the user terminal 1500. Then, the server system 1100 accepts a selection operation of the type of character to be the control target character 6 from the list (step S84).

Next, the server system 1100 accepts the selection of the selection player 7 (step S86). For example, the server system 1100 displays a list of users other than the player 3 on the user terminal 1500, accepts a selection operation for at least two other users, and sets the selected other users as the selection players 7. Also, for example, the server system 1100 displays an input field for a user account on the user terminal 1500, so that desired other users can be directly specified.

On the other hand, if the fourth operation icon 24 is selected, the server system 1100 deems that the player who desires automatic control has performed a request operation for automatic setting of the control target character 6 to be a ghost character (automatic selection in step S82).

The server system 1100 then calculates the recommendation degree for each type of candidate character using the character recommendation degree calculation function 570 (see FIG. 7) and selects the type of the control target character 6 (step S90). The server system 1100 also calculates the recommendation degree for each user other than the player 3 using the selection player recommendation degree calculation function 572 and selects a plurality of selection players 7 (step S92).

Next, the server system 1100 sets the mixing ratio (step S94). That is, the server system 1100 searches the mixing ratio definition data 540 (see FIG. 9) for definition data that satisfies the application requirement 541, and determines the mixing ratio according to the mixing ratio setting 550 (see FIG. 8).

Next, the server system 1100 refers to the user management data 600 (see FIG. 4) of each of the plurality of selection players 7, and reads out the operation individuality information 620 of the character-specific data set 615 in which the used character type 617 matches the control target character type 710. Then, out of the read-out operation individuality information 620 of each of the plurality of selection players 7, the server system 1100 copies and sets the detailed item 621 including the action probability 625 corresponding to a series of actions, into the ghost control information 720 (step S96).

From another perspective, it can be said that the “detailed item 621 including the action probability 625 corresponding to a series of actions” is the detailed item 621 that satisfies a given priority requirement. That is, in step S96, the server system 1100 determines, for each detailed item, which selection player to adopt from among the plurality of selection players 7 so as to meet the given priority requirement, based on the operation individuality information 620 of the selection players 7.

The priority requirement is not limited to this. For example, the priority requirement may relate to the play performance information 630 of the selection player 7 (see FIG. 2). Specifically, the priority requirement may be “the selection player 7 has an effective player technique that is an unfavorable technique for the player 3”. If the priority requirement is adopted, in step S96, the server system 1100 determines, for each detailed item, which selection player to adopt from among the plurality of selection players 7 so as to meet the given priority requirement, based on the play performance information 630 of the selection player 7.

Reference will be made to FIG. 15. The server system 1100 performs the following process for each of the detailed items 721 in the ghost control information 720 that were not set in step S96. That is, the server system 1100 selects one of the detailed items 621 in the operation individuality information 620 of each of the plurality of selection players 7 and the detailed items 521 in the template control information 520, which correspond to the same type of situation, and sets the selected one to the detailed item 721 (step S98).

At the time of setting, the server system 1100 selects detailed items such that the ratio among the number of the detailed items 721 selected from the operation individuality information 620a of a first selecting player 7a, the number of the detailed items 721 selected from the operation individuality information 620c of a second selecting player 7c, and the number of the detailed items 721 selected from the template control information 520 ultimately becomes the mixing ratio set in step S94.

Next, the server system 1100 starts gameplay in the practice mode (step S140), and accordingly starts automatic control with the ghost control information 720 applied to the control target character 6 (step S142; see FIG. 6).

At the end of play (step S150), the server system 1100 ends the practice mode process.

As described above, according to the present embodiment, it is possible to provide a new technology for diversifying automatic control of NPCs that reflects the players' operation individualities.

That is, the game system 1000 selects and copies, for each detailed item 721 of the ghost control information 720, the detailed item 621 of the operation individuality information 620 of any of the plurality of selection players 7. Therefore, it is apparent that the content of the ghost control information 720 varies depending on which user to select as the selection player 7. In addition, the operation individuality of the selection player 7 far exceeds the number of template characters prepared as NPCs by the game creator. This increases the diversity of actions of the control target character 6 automatically controlled using the ghost control information 720.

Since the detailed items 621 have an action probability 625 set for each situation type 623, the detailed items 621 are units that represent the operation individuality of the selection player 7 in the situation type 623. Therefore, when the control target character 6 is automatically controlled based on the ghost control information 720, the actions of the control target character 6 will be mixed with the operation individualities of the plurality of selection players 7. Since a conventional NPC called a ghost character was limited to reproducing the recorded results of the operation inputs of one player (operation information 705 in this specification), its actions reflect only the operation individuality of one player. However, the ghost character of the present embodiment reflects the operation individualities of the plurality of players, and its actions become much more diverse than those of a conventional ghost character.

Furthermore, the recommendation degrees of the plurality of selection players 7 are calculated based on the operation individuality information 620 and play performance information 630 of the player 3, and the operation individuality information 620 of other users who are candidates for the selection player 7, and the selection players 7 to be referenced are selected based on the ranking of the recommendation degrees (see FIG. 7). Therefore, appropriately calculating the recommendation degrees makes it possible to select the selection player 7 having an operation individuality that is unfavorable to the player 3. The control target character 6 controlled by the ghost control information 720 in which the operation individualities of the plurality of selection players 7 selected in this way are mixed will be an unprecedented and suitable practice NPC.

### Second Embodiment

Next, a second embodiment to which the present disclosure is applied will be described. The second embodiment is basically implemented in the same manner as the first embodiment, but differs in the method of generating ghost control information 720. In the description of the second embodiment, the differences from the first embodiment will be mainly described, and the same components as those in the first embodiment will be given the same referential numerals as in the first embodiment, and duplicate description will be omitted.

The functional configuration of a server system 1100 is basically the same as that of the first embodiment (see FIG. 10). However, a control information generation section 216 in the second embodiment generates the ghost control information 720 by compositing operation individuality information 620 of a plurality of selection players 7 at a given ratio for each of detailed items. The given ratio is a ratio 556 of mixing ratio definition data 540 (see FIG. 9). That is, the control information generation section 216 in the second embodiment determines the ratio of each of the detailed items based on the operation individuality information 620 of the plurality of selection players 7.

One or all pieces of the mixing ratio definition data 540 may have a template ratio 556c set to “0” and the other ratios 556 set to be equal to each other. In this case, the control information generation section 216 in the second embodiment generates the ghost control information 720 by calculating the average of the operation individuality information 620 of the plurality of selection players 7 for each of the detailed items.

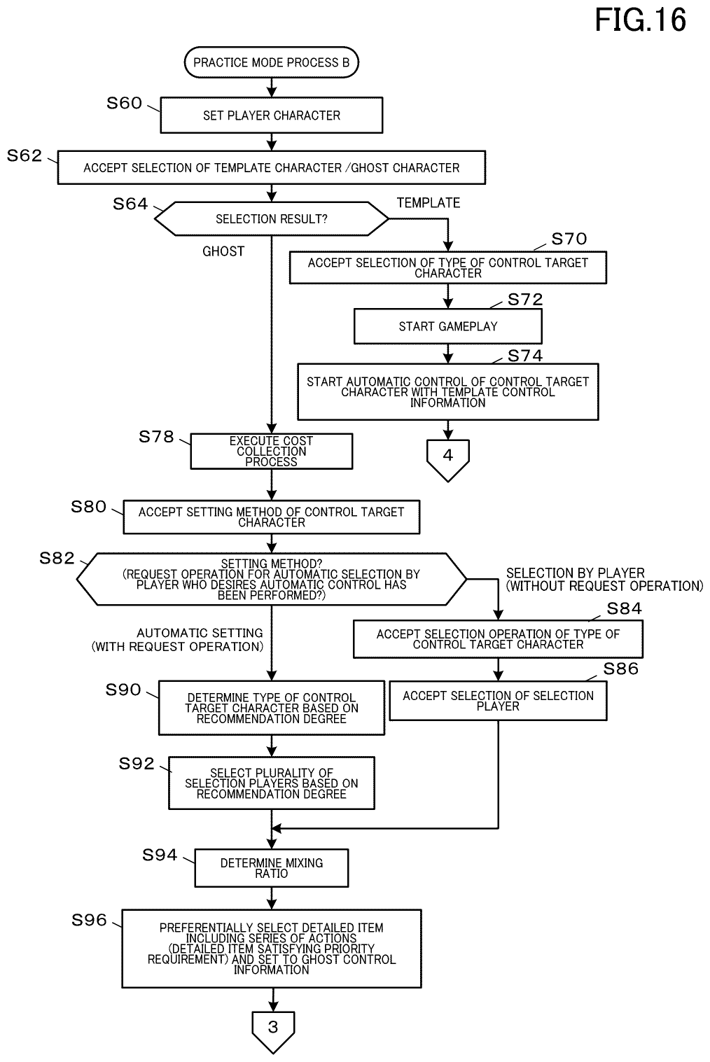

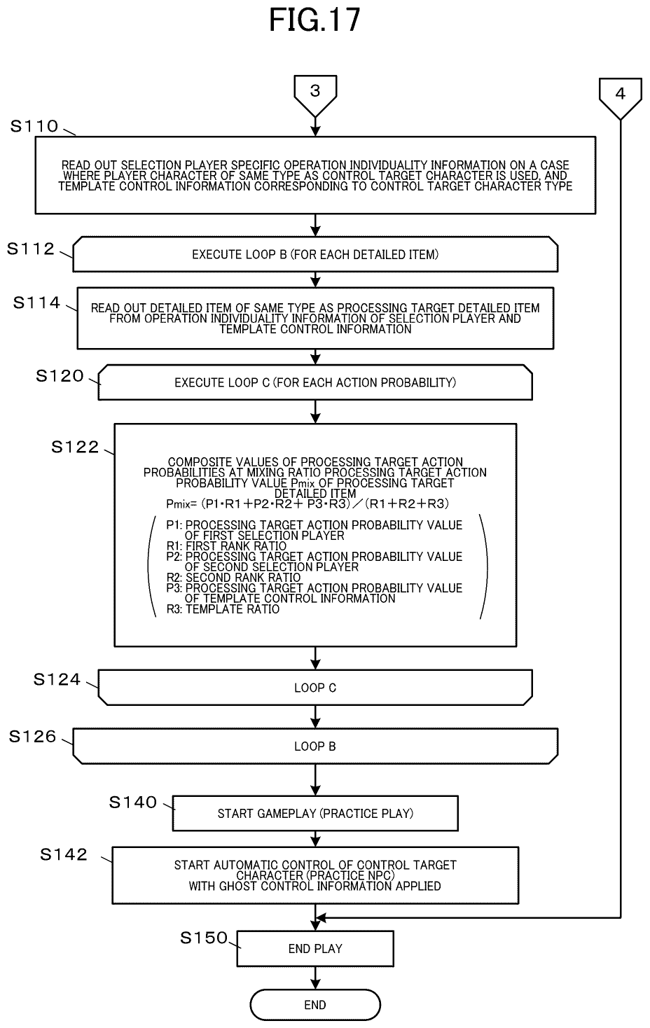

FIGS. 16 and 17 are flowcharts for describing a flow of practice mode process (practice mode process B) in the second embodiment. The practice mode process B basically has the same flow as the practice mode process in the first embodiment, but as shown in FIG. 17, steps S110 to S126 are executed instead of steps S98 to S102.

That is, the server system 1100 refers to user management data 600 (see FIG. 4) of each of the plurality of selection players 7, and reads out the operation individuality information 620 of a character-specific data set 615 in which a used character type 617 matches a control target character type 710, and template control information 520 corresponding to the control target character type 710 (step S110).

Next, the server system 1100 executes a loop B for each detailed item 721 of the ghost control information 720 for the plurality of pieces of read-out operation individuality information 620 and template control information 520 (steps S112 to S126).

In the loop B, the server system 1100 reads out detailed items 621 and detailed items 521 of the same type as the processing target detailed items 721, from the plurality of pieces of read-out operation individuality information 620 and template control information 520 (step S114).

Then, the server system 1100 executes a loop C for each type of action probability 725 included in the processing target detailed items 721 in the loop B (steps S120 to S124).

In the loop C, the server system 1100 reads out the action probabilities 625 and 525 corresponding to the same action as the processing target action probability 725 from the detailed items 621 and 521 readout in step S114. The server system 1100 composites them at the mixing ratio 556 (see FIG. 9) determined in step S94. The server system 1100 sets the composited value as the value of the processing target action probability 725 in the loop C (step S122), and ends the loop C (step S124).

Upon completion of execution of the loop C for all types of action probabilities 725 included in the processing target detailed items 721 in the loop B, the server system 1100 ends the loop B (step S126).

Then, upon completion of execution of the loop B for all the detailed items 721 of the ghost control information 720, the server system 1100 starts gameplay in the practice mode (step S130).

The second embodiment can provide the same advantageous effects as those of the first embodiment.

### MODIFICATION EXAMPLES

The embodiments to which the present disclosure is applied have been described above. However, the mode to which the present disclosure is applicable is not limited to the embodiments, and various modifications may be made as appropriate, such as adding other components, or omitting or changing some of the components.

### Modification Example 1

Although the above-described embodiments have been described as examples of a fighting game, the game genre is not limited to this. The game may be one in which a control target character 6, which is an NPC, is used as an ally NPC rather than an opponent. The character design of the control target character 6 is not limited to a human form. For example, the game may be one in which a combat vehicle such as a warship or tank is operated as a player character.

Depending on the content of the game, a player character 4 may be a target to be trained by a player 3. The game may proceed by automatically controlling the player character 4 using operation individuality information 620 as control information, instead of operating the player character 4 by the player himself/herself. For example, the game may be a horse-training and horse-racing game in which the player trains the player character 4, which is a racehorse, and automatically controls it to run in the derby together with other NPCs, enjoying the results of the training.

Depending on the content of the game, the number of control target characters 6 automatically controlled at the same time is not limited to one, unlike in the above embodiment.

For example, in an army-vs-army war simulation game, there may be a plurality of player characters 4 and a plurality of control target characters 6, and the plurality of control target characters 6 may be automatically controlled at the same time as in the above-described embodiment. In this case, if a plurality of ghost control information 720 are generated, selection sources of detailed items 621 from the operation individuality information 620 may vary depending on the ghost control information 720.

### Modification Example 2

In the above-described embodiments, a server system 1100 executes the processes related to game progress control (e.g., steps S140 and S142 in FIG. 15). Alternatively, the processes may be executed by a user terminal 1500. Specifically, the server system 1100 generates ghost control information 720 and transmits it to the user terminal 1500. The user terminal 1500 may use the received ghost control information 720 to automatically control a control target character 6.

### Modification Example 3

In the above-described embodiments, the ghost control information 720 is created as an example. Alternatively, the creation of the ghost control information 720 can be omitted.

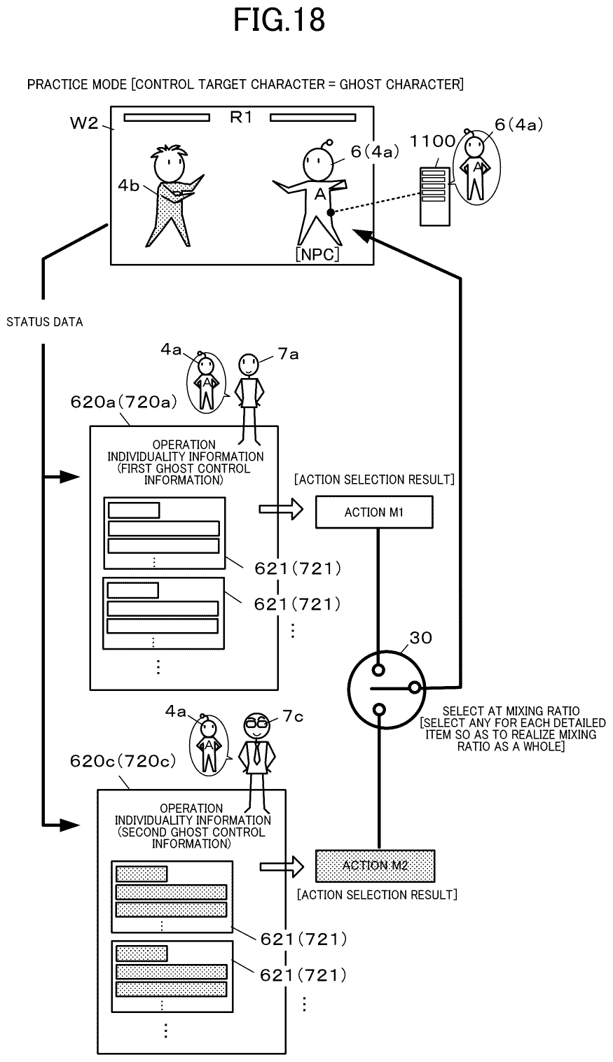

For example, as shown in FIG. 18, in automatic control of a control target character 6, “deemed automatic control” in which operation individuality information 620 (620a, 620c) of a selection player 7 (7a, 7c) is treated as the ghost control information 720 (720a, 720c) of the control target character 6 is executed in parallel. Then, from each of the pieces of the ghost control information 720 (720a, 720c), an action suitable for the situation from time to time is determined one by one. In the example of FIG. 18, an action M1 is determined as a result of the “deemed automatic control” using the ghost control information 720a, and an action M2 is determined as a result of the “deemed automatic control” using the ghost control information 720c.

A server system 1100 automatically controls the control target character 6 by switching selections between the action M1 originating from the first selection player 7a and the action M2 originating from the second selection player 7c using a virtual switch 30. The selection is performed so as to achieve the mixing ratio determined in step S94. The switching is performed so as to preferentially select a series of actions.

By replacing steps S96 and S98 with such a processing flow, even if the creation of the ghost control information 720 is omitted, the operation individuality of the selection player 7 can be reflected in the automatic control of the control target character 6. [0249](Modification Example 4) Regarding the actions taken by the control target character 6 during automatic control, a commentary or live commentary voice may be output or an explanation may be displayed. For example, when the control target character 6 takes an action under automatic control, a commentary or live commentary voice may be output, or an explanation may be displayed as part of the control, such as who was the selection player 7 of the source operation individuality information 620 that caused the action, what was its play level, and which situation type 723 caused the action.

Although only some embodiments of the present invention have been described in detail above, those skilled in the art will readily appreciate that many modifications are possible in the embodiments without materially departing from the novel teachings and advantages of this invention. Accordingly, all such modifications are intended to be included within scope of this invention.

1. A computer system comprising at least one processor or circuit programmed to execute:
generating operation individuality information, which is a gathering of information for each of predetermined detailed items, for each player playing a game, based on operation information of a player character by the player;
generating control information for use in automatic control of a given control target character, based on the operation individuality information of a plurality of selection players; and
automatically controlling the control target character using the control information.

2. The computer system as defined in claim 1, wherein generating the control information includes generating the control information by selecting, for each of the detailed items, the operation individuality information of the selection player to be adopted.

3. The computer system as defined in claim 2, wherein generating the control information includes selecting the operation individuality information of the selection player to be adopted for each of the detailed items such that the operation individuality information is at a given ratio among the players.

4. The computer system as defined in claim 2, wherein generating the control information includes selecting a selection player to be adopted from the plurality of selection players based on the operation individuality information of the selection player.

5. The computer system as defined in claim 2, wherein generating the control information includes selecting a selection player to be adopted from the plurality of selection players based on play performance information of the selection player.

6. The computer system as defined in claim 1, wherein generating the control information includes generating the control information by compositing the operation individuality information of the plurality of selection players at a given ratio for each of the detailed items.

7. The computer system as defined in claim 6, wherein generating the control information includes generating the control information by averaging the operation individuality information of the plurality of selection players for each of the detailed items.

8. The computer system as defined in claim 6, wherein generating the control information includes determining the ratio of each of the detailed items based on the operation individuality information of the plurality of selection players.

9. The computer system as defined in claim 1, wherein
the game is a game in which the player operates a character selected from a plurality of types of characters prepared in advance, as a player character,
generating the operation individuality information includes generating the operation individuality information for each of the plurality of types of characters, based on the operation information in a case where the character is set as a player character, and
performing the automatic control includes automatically controlling the control target character, based on the operation individuality information in a case where a character corresponding to the type of the control target character is set as a player character, among the operation individuality information of the selection player.

10. The computer system as defined in claim 1, wherein performing the automatic control includes:
performing the automatic control in response to a request operation of a player who desires the automatic control; and
performing a cost collection control for collecting a given cost from the player who desires the automatic control.

11. The computer system as defined in claim 10, wherein performing the automatic control includes changing a degree of automatic control of the control target character according to the operation individuality information, based on the amount of the cost.

12. The computer system as defined in claim 1, further programmed to execute selecting the selection player based on an operation input of a player who desires the automatic control.

13. The computer system as defined in claim 1, further programmed to execute selecting the selection player based on play performance information of a player who desires the automatic control.

14. The computer system as defined in claim 1, wherein the operation individuality information includes information indicating what action the player character is made to take in a given game situation.

15. The computer system as defined in claim 14, wherein the operation individuality information includes information on a series of actions taken by the player character.

16. A game control method executed by a computer system, the game control method comprising:
generating operation individuality information, which is a gathering of information for each of predetermined detailed items, for each player playing a game, based on operation information of a player character by the player;
generating control information for use in automatic control of a given control target character, based on the operation individuality information of a plurality of selection players; and
automatically controlling the control target character using the control information.
